(19) United States
(12) Patent Application Publication
(10) Pub. No.: US 2015/0289448 A1
(43) Pub. Date: Oct. 15, 2015

(54) PICK-UP ASSEMBLY AND PICK-UP METHOD WITH AN OVERLOAD PROTECTION

(71) Applicant: FORAGE INNOVATIONS B.V., Maassluis (NL)

(72) Inventor: Steffen Hoffmann, Maassluis (NL)

(73) Assignee: FORAGE INNOVATIONS B.V., Maassluis (NL)

(21) Appl. No.: 14/418,879

(22) PCT Filed: Jul. 31, 2013
(86) PCT No.: PCT/NL2013/050571

§ 371 Date: Jan. 30, 2015

(30) Foreign Application Priority Data
Aug. 2, 2012 (NL) 2009265

(51) Int. Cl. A01D 89/00; A01F 15/10; A01D 75/18

(52) U.S. Cl. CPC A01D 89/002; A01D 75/182; A01F 15/10

(57) ABSTRACT

A pick-up assembly and a pick-up method are provided for picking-up loose material from the ground and including an overload protecting mechanism. A tine bar carrier assembly is rotated around a carrier rotating axis. At least one tine bar is mounted at the tine bar carrier assembly. The tine bar carries several pick-up tines and can be rotated with respect to the tine bar carrier assembly around a bar rotating axis. A tine bar lever connects the tine bar with a retaining mechanism. The retaining mechanism urges the tine bar into a standard rotational position with respect to the tine bar carrier assembly. A rigid object can rotate the tine bar against the force of the retaining mechanism.

### 1. FIELD OF THE INVENTION

The invention refers to a pick-up assembly and a pick-up method for picking up loose material from the ground. Such a pick-up assembly and method are in particular used in a bale forming apparatus for forming a cuboid or cylindrical bale from loose material, in particular from agricultural crop material.

A pick-up assembly according to the invention picks up the loose material by means of several pick-up tines which are mounted on a drum-shaped tine carrier arrangement. The tine carrier arrangement is rotated around a rotating axis perpendicular to the travelling direction of the baler.

The pick-up assembly can hit a rigid object, e.g. a stone, lying on the ground. Several mechanisms for protecting the pick-up assembly from being damaged were disclosed. Such mechanisms can be denoted as overload protecting mechanisms.

### 2. BACKGROUND OF THE INVENTION

U.S. Pat. No. 1,850,458 discloses a pick-up unit for harvesting machines (threshers). Several rake or pick-up teeth 19 are mounted on rake bars or shafts 18, cf. FIG. 1 and FIG. 2. These bars 18 are carried by bearing sleeves 17. By means of crank arms 20 the angularity of the pick-up teeth 19 can be changed. A bolt or pin 31 is fixed at the shaft 18, cf. FIG. 2. One end of a cushion spring 32 is hooked around the pin 31, cf. FIG. 2 and FIG. 5. The other end of the spring 32 is guided into one hole 33 in the crank arm 20. Several holes 34 extend along the crank arm 20, cf. FIG. 4. One hole is the hole 33 with the end of the spring 32. If a strain or pressure is applied to the teeth 19 mounted on the bar 18, the bar 18 carrying the rake teeth 19 can swing against the cushioning action of the springs 32.

German patent specification (Auslegeschrift) DE 1049139 describes a pick-up device (Sammelvorrichtung) for picking up crop material (Erntegut) from the ground. A hub (Nabe 2) carries two connected disks (Scheiben 3, 4), cf. FIG. 2. The disks 3, 4 carry three rocker elements (Schwingen 37). Every rocker element 37 carries a pair of double tines (Doppelzinken 6, 7). Every double tine 6, 7 has the shape of a U, cf. FIG. 2. The double tine 6, 7 is connected via a lever (Hebel 39) with a pressing spring (Druckfeder 11). If a tine 6, 7 hits an obstacle on the ground, the tine 6, 7 is pivoted backwards and compresses the spring 11. The lever 39 is moved away from a limiting element (Anschlag 40). As soon as no obstacle presses against the tines 6, 7, the spring 11 rotates back the tines 6, 7. The lever 39 hits the limiting element 40 and moves the rocker element 37 towards a further limiting element (Anschlag 42).

FIG. 1 of GB 1464991 B shows a pick-up unit 1 and two feeder rakes 2 being arranged above the pick-up unit 1. Every feeder rake 2 comprises a tine carrier 11 and several tines. Every feeder rake 2 urges crop material into a baling chamber 4. The tips of the moved tines perform a movement along a closed path 10. The tines are moved via a crank 5 by a swinging rod 9. A hydraulic or pneumatic cylinder 16 is connected with the tine carrier 1 and with a pin 17. This cylinder 16 can pivot the tine carrier 11 into an inoperative position 20. In this inoperative position 20 the tines cannot hit an obstacle on the ground.

In DE 3340685 C2 a pick-up drum (Aufsammeltrommel 1) with four parallel tine carriers (Zinkenträger 3) is described, cf. FIG. 1 and FIG. 3. The two ends 3′ of a tine carrier 3 are carried in two bearings (Lagerungen 13). The bearings and their housing (Lagergehäuse 12) can be rotated around a central shaft (Welle 11) and are inserted into bearing disks (Lagerscheiben 10). Every tine carrier 3 carries several tines (Zinken 6). A drum (Trommelmantel 2) surrounds the central shaft 11 and the four tine carriers 3. The tines 3 protrude through slots (Schlitze 5) which are cut into the surface of the drum 2. A pre-tensioning means urges every tine 6 against the front end 8 of such a slot 5. A rotating tine 6 passes a slot 5 and a further slot 33 between two spring-mounted strips made of steel (Federstahlstreifen 16). These strips 16 strip off crop material from the tines 6.

EP 0903077 B1 discloses a pick-up unit for crop material. A pick-up drum (Aufnahmetrommel 2) carries several protruding tines (Zinken 3) and rotates in the direction of the arrow 20 of FIG. 1. Several disk-shape hubs (Naben 22) carry the shell of the drum (Trommelmantel 26). The hubs 22 have apertures for several lateral tine carriers (Zinkenträger 35) and carry several tines 3.

The crop material picker of EP 2147590 B1 comprises a lateral shaft (Welle 68) which is mounted on a drive shaft (Antriebswelle 80). The lateral shaft 68 extends along the width of the picker unit and is rotatably mounted on a frame (Gehäuse 32), cf. FIG. 1 and FIG. 2. Two disk-shaped holding elements (Halterungen 70) carry four U-shaped tine carriers (Zinkenträger 74). The drive shaft 80 and the shaft 68 can be rotated in a normal working direction, cf. FIG. 4. In case of a jam or an obstacle the drive shaft 80 in the shaft 68 can be driven in an inverted direction, cf. FIG. 5. The tines carries 74 pivot around several pivot axes being parallel to the drive shaft 80, cf. FIG. 4 and FIG. 5.

### 3. SUMMARY THE INVENTION

An object of the invention is to provide a pick-up assembly with several pick-up tines and a robust and mechanically simple overload protecting mechanism where the protecting mechanism does not require an own spring for every pick-up tine. A further object is to provide a pick-up method using such a pick-up assembly.

The problem is solved by a pick-up assembly with the features of claim 1 and a pick-up method according to claim 13. Preferred embodiments are specified in the depending claims.

The pick-up assembly according to the invention is adapted for picking up loose material from the ground.

Several pick-up tines pick up this loose material. A tine bar carries a plurality of these pick-up tines. The tine bar is mounted at a tine bar carrier assembly. The tine bar carrier assembly is mounted at a pick-up frame.

The tine bar carrier assembly is rotated with respect to the pick-up frame around a carrier rotating axis. This rotation makes the tine bar with the pick-up tines rotating around the carrier rotating axis.

The tine bar is rotatable and is not rigidly connected with the tine bar carrier assembly but is rotatable connected. The tine bar can rotate with respect to the tine bar carrier assembly around a bar rotating axis.

A retaining mechanism urges a retaining force onto the tine bar. This retaining force urges the rotatably mounted tine bar in a standard rotational position with respect to the tine bar carrier assembly. This standard rotational position serves as the regular working position in which the tines on the tine bar pick up loose material from the ground.

A rigid object picked up by a tine can urge the tine bar out of the standard rotational position by rotating the tine bar around the bar rotating axis. This rotation is urged against the retaining force of the retaining mechanism.

A tine bar lever mechanically connects the tine bar with the retaining mechanism. The retaining mechanism applies the retaining force onto the tine bar lever. This force application urges the connected tine bar into the standard rotational position as soon as the overload situation has terminated.

### 4. ADVANTAGES

According to the invention the tine bar carrying several pick-up tines can rotate around the tine bar rotating axis with respect to the tine bar carrier assembly. If some tines mounted on this tine bar are subjected to an overload situation, e.g. by picking up a stone from the ground, the whole tine bar can swing or rotate away from the standard rotational position against the retaining force applied by the retaining mechanism. As soon as the overload situation is removed, e.g. as soon as the stone drops on the ground and leaves the path of movement of the rotating pick-up tines, the retaining mechanism moves automatically back the tine bar in the standard rotational position. Therefore the overload situation does not damage a tine. It is possible but thanks to the invention not necessary to disengage or to switch off or to stop the pick-up assembly for removing the overload situation. In contrast the tine bar carrier assembly with the tine bar can continuously be rotated even in the case of an overload situation.

According to the invention the retaining mechanism urges the tine bar into the standard rotational position with respect to the tine bar carrier assembly. Therefore the retaining mechanism arranged according to the invention saves the need to provide every single tine with an own retaining element. In particular it is possible but not necessary to provide every tine with an own spring.

Thanks to the invention only a limited number of parts of the pick-up assembly are set in motion by an overload situation, in particular compared with an embodiment where every pick-up tine is secured with an own spring. The tine bar lever is rotated away from the standard rotational position due to an overload situation but is not changed in its length or shape. Only the retaining mechanism itself is typically stretched or compressed because of the overload situation. Therefore the invention leads to a pick-up assembly which reduces the stress applied to the parts of the pick-up assembly. This reduces the effort being necessary for maintenance and repair.

The overload protecting mechanism according to the invention does not require a sensor for monitoring the pick-up assembly. It does also not require a specific drive for actively moving or rotating the tine bar carrier assembly or the tine bar specifically in case of an overload situation. The overload protecting mechanism according to the invention only requires passive mechanical parts.

According to the invention the retaining mechanism is not directly connected with the tine bar but with the tine bar lever and with a further part of the pick-up assembly. Therefore the retaining mechanism needs not to be adapted to the shape of the tine bar. The tine bar lever provides a lever arm for urging the rotatable tine bar into the standard rotational position. Therefore the retaining mechanism can be constructed more compact and reliable. In addition the retaining mechanism can apply less force for rotating the tine bar and nevertheless the same effect is achieved. Therefore a smaller retaining mechanism can be used. Space for the retaining mechanism is saved. This space can be used for allowing the tine bar with the pick-up tines to rotate with respect to the tine bar carrier assembly. The invention enables a more reliable and mechanically stable construction than other overload protecting mechanisms.

The invention provides more degrees of freedom while designing the pick-up assembly, in particular the following degrees of freedom:
the length of the tine bar lever,
the length of the provided lever arm, i.e. the difference between the bar rotating axis and the connecting point in which the retaining means is connected with the tine bar lever,
the applied force, the length, the shape, the retaining concept, and further physical parameters of the retaining mechanism.

Therefore it is easier to adapt the pick-up assembly to given constraints, e.g. spatial constraints or to constraints about the force which the pick-up assembly should apply to loose material on the ground.

The invention does not require to lift the tine bar carrier assembly from the ground or to invert the rotating direction of the tine bar carrier assembly for removing an overload situation. But the overload protecting mechanism according to the invention does not inhibit the step of lifting the tine bar carrier assembly, e.g. for adapting it to the ground profile. The overload protecting mechanism also does not preclude inverting the rotating direction of the tine bar carrier assembly.

### 5. PREFERRED EMBODIMENTS

Any suitable biasing means can be used as part of the retaining mechanism. Examples for such biasing means are:
a pulling or tension spring,
a compression spring,
a torsion spring,
a leaf spring,
a coil spring,
a hydraulic cylinder,
a cylinder filled with gas,
a gas strut.

Preferably the tine bar extends along a longitudinal axis. In one embodiment this longitudinal axis coincides with the tine bar rotating axis, i.e. the tine bar can rotate around its own rotational axis. In a further embodiment the tine bar is mounted on at least one pivotal bar lever such that a distance between the longitudinal axis of the tine bar and the bar rotating axis occurs. This bar lever or every bar lever connects the tine bar with the tine bar carrier assembly.

In a preferred embodiment the pick-up assembly is moved over ground in a travelling direction. The tine bar extends in a direction perpendicular to the travelling direction. The carrier rotating axis and the bar rotating axis both are perpendicular to this travelling direction.

Preferably the bar rotating axis is parallel to the carrier rotating axis such that a distance between the rotating tine bar and the carrier rotating axis occurs. It is also possible that the tine bar extends along the carrier rotating axis such that the bar rotating axis coincides with the carrier rotating axis.

In one embodiment a remote drive rotates the tine bar carrier assembly around the carrier rotating axis. A transmission device transmits the rotational movement of the drive to the tine bar carrier assembly. The transmission device can comprise a chain and at least one sprocket wheel or a shaft and gearing, e.g. a bevel gearing.

In a further embodiment the drive is integrated into the pick-up assembly. The drive can comprise an electrical motor or a further suitable motor with an output shaft. This output shaft is rotated by the motor and rotates the tine bar carrier assembly around the carrier rotating axis. The tine bar carrier assembly can have the shape of a drum and the electrical motor is integrated or mounted into this drum.

In one embodiment the tine bar carrier assembly comprises at least one rigid rotatable carrier. This rotatable carrier, e.g. a disk, can rotate with respect to the pick-up frame around the carrier rotating axis. The or every tine bar is mechanically connected with this rotatable carrier and can rotate with respect to the rotatable carrier around the bar rotating axis. Two rotatable carriers can form a pick-up drum which carries the tine bar.

As mentioned above the tine bar can extend long a longitudinal axis which is perpendicular to the travelling direction. The tine bar is supported by a left rotatable carrier and right rotatable carrier wherein the terms left and right refer to the travelling direction. Preferably the tines are arranged between the two rotatable carriers of the tine bar carrier assembly.

In one implementation of this embodiment the tine bar comprises a stub which protrudes laterally from the rotatable carrier or from the tine bar lever. The rotatable carrier extends in a plane. The pick-up assembly is arranged such that the rotatable carrier is between the pick-up tines on the one side and the stub and the retaining mechanism on the other side. In one embodiment the rotatable carrier is also between the tines and the tine bar lever. It is easier for a human operator to get access to the retaining mechanism, e.g. for maintenance purpose, and to replace the retaining mechanism or a part of the retaining mechanism. The stub shows the rotational position of the tine bar with respect to the rotatably carrier.

Preferably a stop element is mounted on the tine bar carrier assembly. This stop element limits a rotational movement of the tine bar around the bar rotating axis. In one implementation the stop element limits a rotational movement of the tine bar lever around the bar rotating axis. The retaining mechanism urges the tine bar against this stop element. The stop element defines the standard rotational position. This embodiment enables to use a retaining mechanism, in particular a spring, which can urge the tine bar in only one direction, namely towards the stop element. The retaining mechanism itself needs not to comprise a limiting element. This enables to use a very simple retaining mechanism.

In one embodiment the tine bar lever is rigidly connected with the tine bar or with the tine bar lever such that the tine bar lever cannot rotate with respect to the tine bar. The retaining mechanism applies a retaining force onto the tine bar lever and by this rotating force the connected tine bar is urged into the standard rotational position.

Preferably the retaining mechanism is connected with the tine bar as well as with the tine bar carrier assembly. Not only the tine bar carrier assembly and the tine bar but also the retaining mechanism is rotated with respect to the pick-up frame around the carrier rotating axis. At least as long as no overload situation occurs, the retaining mechanism does not change its relative position with respect to the tine bar carrier assembly and with respect to the tine bar. This embodiment enables to implement a small retaining mechanism which nevertheless can apply nearly the same retaining force in every rotational position of the tine bar carrier assembly rotating around the carrier rotating axis.

In one embodiment the pick-up assembly comprising the invention operates in a non-controlled manner. As long as no overload situation occurs, every pick-up tine remains its position relative to the tine bar while the tine bar carrier assembly together with the tine bar is rotated around the carrier rotating axis. Only an overload situation can rotate the tine bar with respect to the tine bar carrier assembly around the bar rotating axis and against the force of the retaining mechanism.

In a further embodiment a pick-up assembly comprising the invention operates in a controlled manner. During normal operation the pick-up tines mounted on the tine bar change their position relative to the tine bar carrier assembly while the tine bar is rotated around the carrier rotating axis about 360 degrees. Typically a cam and a cam follower urge the tine bar to rotate around the bar rotating axis during this full rotation of 360 degrees. U.S. Pat. No. 1,850,458 discloses such a pick-up assembly with a shaft 15 acting as the cam and a crank arm 20 for every tine bar 18 acting as a cam follower, cf. FIG. 1.

In one embodiment the retaining means can be adjusted by a human operator during a maintenance process, e.g. a step of adjusting can change the retaining force which the retaining means can apply.

The retaining means is mounted at the tine bar lever and at a further part of the pick-up assembly, preferably at the tine bar carrier assembly. In one implementation of the adjustable retaining means several potential connecting points in the tine bar lever or in the further part are provided, e.g. several holes. The retaining means can be inserted into one of these holes. Switching the retaining means from one hole to a further hole changes the retaining force applied by the retaining means. This implementation applies in particular for a retaining means comprising a spring.

In a further implementation a set screw at the retaining means can be turned for adjusting the retaining means. Or the pressure urged by a fluid in a chamber of the retaining means is amended.

The pick-up assembly according to the invention can be used in a vehicle which is moved over ground and picks up loose material from the ground and processes or stores this picked-up loose material. The loose material can be agricultural crop material (hay, straw, silage, e.g.) or recycling material, (paper or cartridge or foliage, e.g.). The vehicle can be a baler, a combine harvester, a field chopper or a garbage collecting vehicle or a foliage collecting vehicle, e.g.

These and other aspects of the invention and of the preferred embodiment will be even more apparent from the detailed embodiment as described below and will be elucidated in detail there.

### 6. BRIEF DESCRIPTION OF THE DRAWINGS

FIG. 1 shows a square baler with a pick-up assembly;

FIG. 2 shows the pick-up assembly of the invention in a perspective view and in an explosion presentation;

FIG. 3 shows the pick-up assembly of FIG. 2 in a side view.

### 7. DETAILED DESCRIPTION OF EMBODIMENT

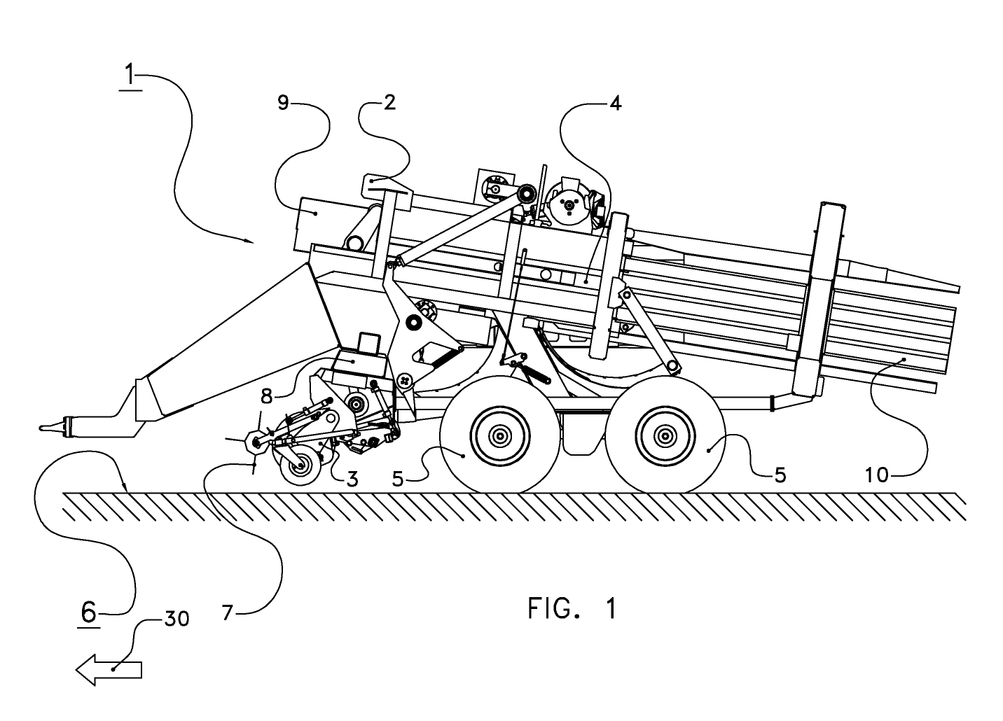

In the embodiment the invention is used in a pick-up assembly 3 of a bale forming apparatus (baler 1). This baler 1 is shown in FIG. 1. The baler 1 forms cuboid bales (also called square bales) from loose agricultural material which is picked-up from the ground 6. Such a bailer is sometimes called a square baler. The invention can also be used in a round baler which creates cylindrical bales.

The baler 1 of the embodiment is not a self-propelled vehicle but is pulled by a tractor or a further moving vehicle with a motor (not shown) over the ground 6 in a travelling direction 30 (in FIG. 1 from right to left).

While the baler 1 is moved over ground 6 and the ground 6 belongs to an agricultural field, the pick-up assembly 3 picks up and lifts loose crop material (hay, straw, silage, e.g.) from the ground 6. In general the crop material is arranged in at least one windrow. The tines 7 are rotated around a rotating axis which is perpendicular to the travelling direction 30. In the example of FIG. 1 the rotating direction is anti-clockwise. A down holder is mounted in a distance above the pick-up assembly 3 and limits the movement of the picked-up crop material and guides this crop material.

The picked-up crop material is conveyed rearwards towards a stuffing apparatus 8. In one embodiment the operating width of the pick-up assembly 3 is larger than the operating width of the subsequent stuffing apparatus 8. In this embodiment the picked-up crop material is conveyed laterally, i.e. perpendicular or sloping with respect to the travelling direction 30. Auger screws, deflecting plates or lateral conveying rotors may be used for shifting the crop material together to the smaller width of the stuffing apparatus 8.

The stuffing apparatus 8 has several stuffing tines which engage into a feeding channel. This feeding channel guides the crop material from the pick-up assembly 3 opposite to the travelling direction 30 to the front part 4 of a pressing channel. The stuffing tines of the stuffing apparatus 8 pre-presses the crop material (while operated in the stuffing mode) and transfers the pre-pressed crop material into the front part 4 (after being switched in the loading mode).

A pressing piston 9 oscillates in the front part 4 of the pressing channel and parallel to the travelling direction 30 of the baler 1. The pressing channel is surrounded by four side walls such that the pressing channel has a rectangular cross section. This cross section may vary over the length of the pressing channel. The oscillating piston 9 presses crop material which was transferred into the front part 4.

A cuboid (square) bale is formed in the pressing channel comprising the front part 4 in which the piston 9 oscillates and the rear part 10. A side wall of the rear part 10 may be pivoted for adapting the cross section of the pressing channel to a required pressure onto the crop material. The created cuboid bale is wrapped into a twine or yarn in the rear part 10. The wrapped cuboid bale is shifted through an outlet of the rear part 10 and out of the pressing channel. The wrapped bale is shifted over a sloping chute which is pivotally connected with the rear part 10. The wrapped bale being shifted over the chute is deposited on the ground 6.

If the invention is used in a round baler, crop material is picked-up by the pick-up assembly 3 in the same way and is shifted into a feeding channel which guides the crop material into a drum-shaped pressing chamber. A conveying rotor with rigid conveying tines urges the crop material through the feeding channel and through an inlet into the pressing chamber. The crop material is rotated in the pressing chamber by means of several pressing rollers and/or pressing belts and rotates around a crop material rotating axis which is perpendicular to the travelling direction 30. The cylindrical bale in the pressing chamber is wrapped into a net or foil and is ejected out of the drum-shaped pressing chamber.

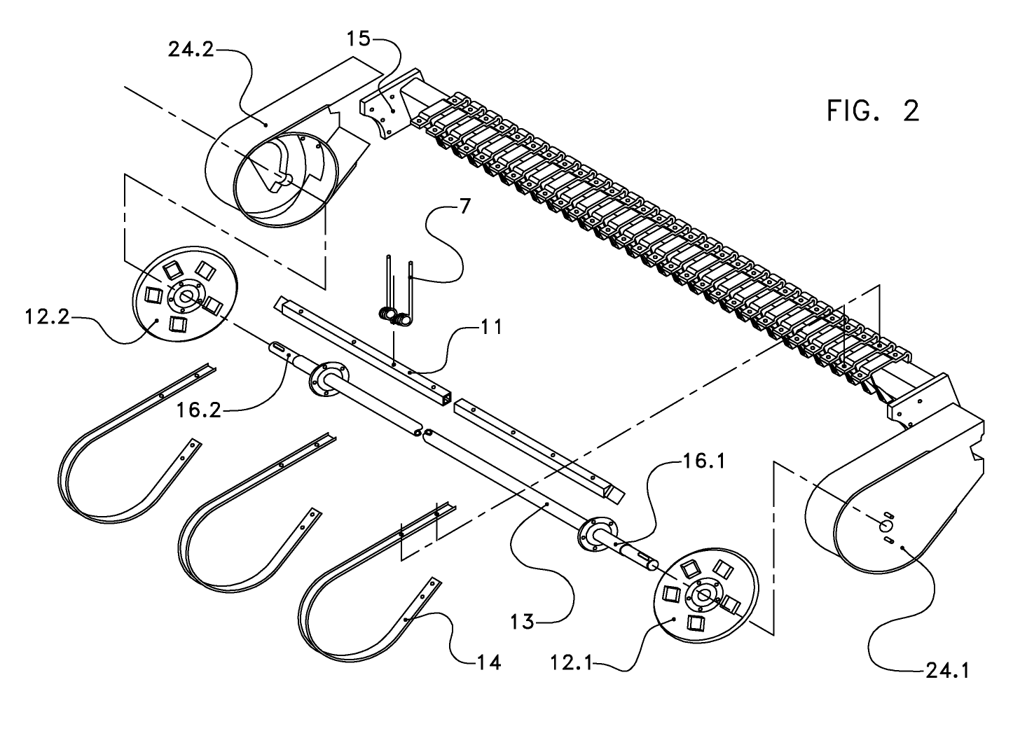

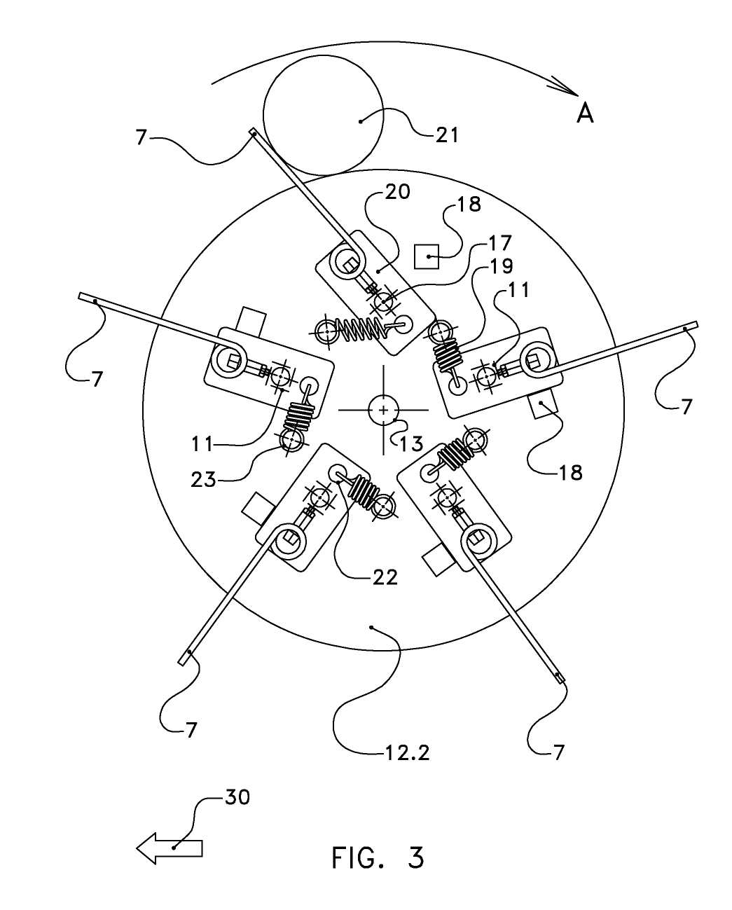

FIG. 2 shows the pick-up assembly 3 schematically in a perspective view. A pick-up frame 15 is mounted at the baler frame 2 and comprises a left cover plate 24.1 and a right cover plate 24.2. The terms “left” and “right” refer to the travelling direction 30 of the baler 1. The pick-up frame 15 carries a rigid shaft 13 with a left stub 16.1 and a right stub 16.2. A disk-shaped left tine bar carrier 12.1 and a disk-shaped right tine bar carrier 12.2 are carried by the pick-up frame 15 and together carry the tine bars 11 for the pick-up tines 7. The two carriers 12.1, 12.2 belong to the tine bar carrier assembly of the embodiment. The cover plates 24.1, 24.2 surround the two carriers 12.1, 12.2. The left stub 16.1 and the right stub 16.2 protrude from the left carrier 12.1 and the right carrier 12.2, resp. The left carrier 12.1 and the right carrier 12.2 each comprise one aperture per tine bar 11. In the embodiment shown in FIG. 2 and FIG. 3 the pick-up assembly 3 comprises five parallel tine bars 11 (only one tine bar 11 is shown in FIG. 2). Two little tine bars stubs per tine bar 11 protrude from the carriers 12.1, 12.2. All pick-up tines 7 are arranged between the two tine bar carriers 12.1, 12.2.

A drive (not shown) rotates the shaft 13 around a carrier rotating axis which coincides with the middle longitudinal axis of the shaft 13. In one embodiment (not shown) a sprocket wheel is rigidly mounted on a stub 16.1 or 16.2. A chain rotates the sprocket wheel and by this the shaft 13. The chain is driven by a further sprocket wheel mounted at the baler frame 2. It is also possible to rotate the shaft 13 by two sprocket wheels which directly engage each other or by a further shaft and a bevel gearing, e.g.

The shaft 13 with the two stubs 16.1, 16.2 as well as the carriers 12.1, 12.2 are rotated around the tine bar rotating axis 13. This makes the five tine bars 11 rotating around the rotating axis 13 such that a distance between the tine bar 11 and the rotating axis 13 occurs.

Every tine 7 is mounted on a tine bar 11. Every tine bar 11 carries a row of tines 7. In FIG. 2 two rigidly connected tines 7 are shown. In this embodiment a spring for securing the tines 7 is shown. But thanks to the invention it is not required to provide an own spring per pick-up tine 7.

Five rows of tines 7 are mounted on the five tine bars 11. All five tines 7 on the five tine bars are arranged in a plane perpendicular to the five parallel tine bars 11 and form one pair of five tines extending like a star from the carrier rotating axis.. Several such pairs each with five tines 7 are arranged along the width of the pick-up assembly 3. The five tines 7 of a pair protrude from two pick-up guards 14. FIG. 2 shows only three pick-up guards 14. Every pick-up guard 14 comprises a U-shaped round segment surrounding the five tine bars 11 and a straight segment which serves as a stripping unit which strips off crop material from the tines 7.

FIG. 3 shows the pick-up assembly 3 in a viewing direction perpendicular to the travelling direction 30 and perpendicular to the shaft 13 and to the five tine bars 11. The drawing plane of FIG. 3 lies close to the right tine bar carrier 12.1. The right tine bar carrier 12.2 can be seen. The right tine bar carrier 12.2, the left tine bar carrier 12.1 (not shown in FIG. 3) and the tine bars 11 rotate around the rotating axis 13 in the working direction A. Every tine bar 11 can rotate with respect to the carriers 12.1, 12.2 around a rotating axis 17 which is parallel to the shaft 13. In FIG. 3 a pair of five tines 7 arranged in a plane is shown. The right carrier 12.2 is behind this pair of five tines.

Every tine bar 11 carries several pick-up tines 7. One tine 7 per tine bar 11 and therefore one pair with five tines 7 is shown in FIG. 3. The pick-up tines 7 which are mounted on a tine bar 11 extend outwards from the tine bar 11. The tines 7 on a tine bar 11 may be equally spaced and may be distributed evenly across the longitudinal axis of the tine bar 11. In the embodiment every tine bar 11 comprises one hole per tine 7 for receiving a tine fastener, e.g. a bolt. The tine 7 comprises a corresponding hole for receiving this fastening bolt.

Every tine 7 comprises a coil segment connected with the tine bar 11 and a straight segment protruding from the tine bar 11 and through a slot between two pick-up guards 14. The spring coil allows the tine 7 to twist or to deflect backwards to allow the tine 7 to automatically react after coming against a small obstruction. The coil segment of the tine 7 may comprise one coil or several coils, i.e. several spiral turns of the tine 7. This straight segment of a tine 7 may comprise a forward bend in the direction of rotation. This forward band facilitates picking up or gathering loose material from the ground and conveying it in the working direction A. The straight segment can also comprise a single solid rod.

According to the embodiment a right tine bar lever 20 and a left tine bar lever (not shown in FIG. 3) are rigidly connected with one tine bar 11. FIG. 3 shows five right tine bar levers 20 for the five tine bars 11. Every tine bar lever 20 can also rotate around the rotating axis 17 of the corresponding tine bar 11. Rotating the tine bar carrier assembly 12.1, 12.2 causes not only the five tine bars 11 but also the five tine bar levers 20 of FIG. 3 and the corresponding left tine bar levers to rotate around the carrier rotating axis 13.

The pick-up assembly 3 of the embodiment comprises five tine bars 11 and at least two tine bar carriers 12.1, 12.2. Every tine bar 11 is secured by means of a right tine bar lever 20 arranged adjacent to the right tine bar carrier 12.2 and a left tine bar lever (not shown in FIG. 3). It is possible that a further tine bar carrier is arranged between the left tine bar carrier 12.1 and the right tine bar carrier 12.2. In this embodiment one further tine bar lever per tine bar is mounted at the intermediate tine bar carrier.

In the embodiment of FIG. 3 the retaining mechanism 19 comprises several tension or pulling springs 19. Every tension spring 19 is pivotally connected with a tine bar carrier 12.2 in a connecting point 23 and with a tine bar lever 20 in a further connecting point 22. As the pick-up assembly 3 comprises two tine bar carriers 12.1, 12.2 and further comprises five tine bars 11, the retaining mechanism comprises at least ten tension springs 19.

As can be seen in FIG. 3, the five tine bar levers 20 and the five tension springs 19 are all arranged on the same side of the disk-shaped tine bar carrier 12.2. This makes it easier for an operator to get access to the tine bar lever 20 and the springs 19 for performing maintenance or repair.

Every tension spring 19 tends to shorten and to shift the further connecting point 22 at the tine bar lever 20 towards the connecting point 23 at the tine bar carrier 12.2. This makes the tine bar lever 20 rotating in the working direction A.

In the embodiment five stop elements 18 are mounted on the right carrier 12.2. Corresponding stop elements (not shown) are mounted on the left carrier 12.1. The tension spring 19 urges the tine bar lever 20 in the working direction A towards this stop element 18. The stop elements 18 are optional. Without such stop elements 18 the rotational movement of a tine bar lever 20 is stopped as soon as the tension spring 19 has reached its minimal length but not earlier. The stop elements 18, however, and the tension springs 19 define exactly the standard rotational position of the tine bar levers 20 and therefore of the tine bars 11 around the respective rotating axis 17. Therefore the stop elements 18 enable a larger tolerance in the positioning and in the operation of the retaining springs 19.

In the embodiment the tine bar 11 is rigidly connected with the assigned tine bar lever 20. Therefore the retaining mechanism 19 does not only urge the tine bar lever 20 but also the connected tine bar 11 and therefore the pick-up tines 7 on this tine bar 11 into the standard rotational position with respect to the tine bar carriers 12.1, 12.2.

During the pick-up operation the tine bar carrier assembly with the two tine bar carriers 12.1, 12.2, the five tine bars 11, the pick-up tines 7, the tine bar levers 20, and the retaining springs 19 are continuously rotated around the carrier rotating axis 13 (perpendicular to the drawing plane of FIG. 3). During normal operation the tine bars 11, the tines 7, the tine bar levers 20 and the retaining springs 19 do not change their respective position with respect to the tine bar carriers 12.1, 12.2 in the course of this rotation.

In the situation shown in FIG. 3 a rigid object 21, e.g. a stone, was picked up and is also conveyed in the working direction A. An overload situation occurs. The stone 21 presses against at least one tine 7 mounted on the upper tine bar 11. The stone 21 urges the tine 7 in a direction opposite to the working direction A and away from the standard rotational position and away from the stop element 18. As the tine 7 is mounted on the upper tine bar 11, the stone 21 and the continuously rotating tine bar carriers 12.1, 12.2 rotate the tine bar 11 away from the standard rotational position and against the force of the retaining spring 19. The upper tine bar lever 20 is rotated away from the assigned limiting stop element 18. The tension spring 19 is extended and applies a retaining force onto the assigned tine bar lever 20.

Several tines 7 on the upper tine bar 11 urge the stone 21 in the working direction A. As soon as the stone 21 can drop, the overload situation does no longer occur.

Reference signs used in the claims will do not limit the scope of the claimed invention. The term “comprises” does not exclude other elements or steps. The articles “a”, “an”, and “one” do not exclude a plurality of elements. Features specified in several depending claims may be combined in an advantageous manner.

### 8. LIST OF REFERENCE SIGNS

| | |
|---|---|
| 1 | bale forming apparatus (baler) |
| 2 | baler frame |
| 3 | pick-up assembly |
| 4 | font part of the bale forming channel |
| 5 | support wheels of the baler 1 |
| 6 | ground over which the baler 1 is moved |
| 7 | pick-up tines, mounted at the tine bars 11 |
| 8 | stuffing apparatus |
| 9 | piston of the baler 1, oscillates in the pressing channel 4, 10 |
| 10 | rear part of the bale forming channel |
| 11 | tine bar, carries several pick-up tines 7 |
| 12.1 | left tine bar carrier, belongs to the tine bar assembly |
| 12.2 | right tine bar carrier, belongs to the tine bar assembly |
| 13 | rigid shaft, serves as rotating axis for the tine bar carrier |
| | assembly with the carriers 12.1, 12.2 |
| 14 | pick-up guards through which the tines 7 protrude |
| 15 | pick-up frame, carries both tine bar carriers 12.1, 12.2 |
| 16.1 | left stub on the carrier rotating axis 13, protrudes out of the |
| | left carrier 12.1 |
| 16.2 | right stub on the carrier rotating axis 13, protrudes out of the |
| | right carrier 12.2 |
| 17 | rigid axle, serves as they rotating axis for the tine bar 11 |
| 18 | stop element, limits the rotational movement of the tine bar 11 |
| | around the rotating axis 17 |
| 19 | pulling spring for urging the tine bar lever 20 into the standard |
| | rotational position, serves as retaining means |
| 20 | tine bar lever, can rotate around the bar rotating axis 17 |
| 21 | rigid object (a stone, e.g.) which was picked-up |
| 22 | connecting point in which the pulling spring 19 is connected with |
| | the tine bar lever 20 |
| 23 | connecting point in which the pulling spring 19 is connected with |
| | the right tine bar carrier 12.2 |
| 24.1 | left cover plate of the pick-up frame 15 |
| 24.2 | right cover plate of the pick-up frame 15 |
| 30 | travelling direction of the baler 1 |
| A | working rotating direction of the pick-up assembly 3 |

1. A pick-up assembly for picking-up loose material from the ground, the pick-up assembly comprising:
a pick-up frame;
at least one tine bar;
several pick-up tines mounted on the tine bar;
a tine bar carrier assembly;
at least one tine bar lever; and
a retaining mechanism for the tine bar,
wherein the tine bar carrier assembly is mounted on the pick-up frame such that the tine bar carrier assembly can rotate with respect to the pick-up frame around a carrier rotating axis, the tine bar is mounted at the tine bar carrier assembly such that the tine bar can rotate with respect to the tine bar carrier assembly around a bar rotating axis, the or every tine bar lever mechanically connects the tine bar with the retaining mechanism, the retaining mechanism is adapted for applying a retaining force onto the or every tine bar lever, the retaining force urges the connected tine bar in a standard rotational position with respect to the tine bar carrier assembly, the pick-up assembly is arranged such that the tine bar can be rotated with respect to the tine bar carrier assembly around the bar rotating axis away from the standard rotational position and against the retaining force applied by the retaining mechanism.

2. The pick-up assembly according to claim 1, wherein the tine bar extends along a longitudinal axis, the retaining mechanism is connected with the tine bar lever in a connecting point, the bar rotating axis is arranged between the tines mounted on the tine bar and the connecting point, if seen in a viewing direction parallel to the longitudinal axis.

3. The pick-up assembly according to claim 1, wherein a stop element is mounted on the tine bar carrier assembly, and wherein the stop element is adapted for limiting a rotational movement of the tine bar around the bar rotating axis.

4. The pick-up assembly according to claim 3, wherein the stop element is adapted for limiting a rotational movement of the tine bar urged by the retaining force applied by the retaining mechanism.

5. The pick-up assembly according to claim 1, wherein:
the tine bar carrier assembly comprises at least one rotatable carrier;
the or every rotatable carrier is adapted for being rotated with respect to the pick-up frame around the carrier rotating, axis;
the tine bar is mounted at the or every rotatable carrier such that the tine bar can rotate with respect to the or every rotatable carrier around the bar rotating axis, and
the retaining mechanism comprises at least one retaining element per rotatable carrier and per tine bar.

6. The pick-up assembly according to claim 5, wherein the or every rotatable carrier of the tine bar carrier assembly extends in a plane and the retaining element is arranged at one side of the rotatable carrier extending in a plane.

7. The pick-up assembly according to claim 5, wherein the pick-up assembly is arranged such that the rotatable carrier of the tine bar carrier assembly is arranged between the assigned retaining element and the tines mounted on the tine bar.

8. The pick-up assembly according to claim 1, wherein the retaining mechanism is connected with the tine bar carrier assembly such that the tine bar carrier assembly, the tine bar and the retaining mechanism together can be rotated around the carrier rotating axis.

9. The pick-up assembly according to claim 1, wherein the retaining mechanism comprises a tension spring, wherein the tension spring tends to shorten and is connected with the tine bar lever such that shortening of the tension spring urges the tine bar into the standard rotational position.

10. The pick-up assembly according to claim 1, wherein the pick-up assembly comprises at least two parallel tine bars, wherein every tine bar can rotate around a bar rotating axis thereof, comprises a rotating mechanism for urging the tine bar in its respective standard rotational position, and is connected with at least one tine bar lever.

11. The pick-up assembly according to claim 1, wherein the bar rotating axis around which the tine bar can rotate is parallel to and is spaced away from the carrier rotating axis around which the tine bar carrier assembly can rotate.

12. A vehicle adapted for travelling over ground, the vehicle comprising:
the pick-up assembly according to claim 1 for picking up loose material from the ground;
a processing assembly for processing and/or for storing loose material; and
a conveying assembly for conveying loose material picked-up from the ground to the processing assembly.

13. A method for picking up loose material from the ground by means of a pick-up assembly, the pick-up assembly comprising:
a pick-up frame.
at least one tine bar, bar;
several pick-up tines mounted on the tine, bar;
a tine bar carrier assembly;
at least one tine bar lever; and
a retaining mechanism for the tine bar,
wherein the tine bar is mounted at the tine bar carrier assembly and can rotate with respect to the tine bar carrier assembly around a bar rotating axis, and wherein the tine bar lever mechanically connects the tine bar with the retaining mechanism,
the method comprising the steps of:
rotating the tine bar carrier assembly with respect to the pick-up frame around a carrier rotating, axis, wherein:
the rotation of the tine bar carrier assembly causes the tine bar to be rotated around the carrier rotating axis, and the rotation of the tine bar around the carrier rotating axis causes the pick-up tines to rotate and to pick up loose material from the ground;
the retaining mechanism applies a retaining force onto the tine bar lever and this application of the retaining force urges the connected tine bar into a standard rotational position with respect to the tine bar carrier assembly; and
the event that a rigid object is picked-up by a pick-up tine mounted on the tine bar has the effect that the tine bar is rotated with respect to the tine bar carrier assembly around the bar rotating axis away from the standard rotational position and against the force of the retaining mechanism.

14. The pick-up assembly according to claim 2, wherein a stop element is mounted on the tine bar carrier assembly, and wherein the stop element is adapted for limiting a rotational movement of the tine bar around the bar rotating axis.

15. The pick-up assembly according to claim 2, wherein:
the tine bar carrier assembly comprises at least one rotatable carrier;
the or every rotatable carrier is adapted for being rotated with respect to the pick-up frame around the carrier rotating axis;
the tine bar is mounted at the or every rotatable carrier such that the tine bar can rotate with respect to the or every rotatable carrier around the bar rotating axis; and
the retaining mechanism comprises at least one retaining element per rotatable carrier and per tine bar.

16. Pick-up assembly according to claim 3, wherein:
the tine bar carrier assembly comprises at least one rotatable carrier;
the or every rotatable carrier is adapted for being rotated with respect to the pick-up frame around the carrier rotating axis;
the tine bar is mounted at the or every rotatable carrier such that the tine bar can rotate with respect to the or every rotatable carrier around the bar rotating axis; and
the retaining mechanism comprises at least one retaining element per rotatable carrier and per tine bar.

17. Pick-up assembly according to claim 4 wherein:
the tine bar carrier assembly comprises at least one rotatable carrier;
the or every rotatable carrier is adapted for being rotated with respect to the pick-up frame around the carrier rotating axis;
the tine bar is mounted at the or every rotatable carrier such that the tine bar can rotate with respect to the or every rotatable carrier around the bar rotating axis; and
the retaining mechanism comprises at least one retaining element per rotatable carrier and per tine bar.

18. Pick-up assembly according to claim 6, the pick-up assembly is arranged such that the rotatable carrier of the tine bar carrier assembly is arranged between the assigned retaining element and the tines mounted on the tine bar.

19. Pick-up assembly according to claim 2, wherein the retaining mechanism is connected with the tine bar carrier assembly such that the tine bar carrier assembly, the tine bar and the retaining mechanism together can be rotated around the carrier rotating axis.

20. Pick-up assembly according to claim 3, wherein the retaining mechanism is connected with the tine bar carrier assembly such that the tine bar carrier assembly, the tine bar and the retaining mechanism together can be rotated around the carrier rotating axis.
